(19) United States
(12) Patent Application Publication
(10) Pub. No.: US 2014/0274109 A1
(43) Pub. Date: Sep. 18, 2014

(54) POSITIONING PERFORMANCE PREDICTION

(71) Applicant: QUALCOMM INCORPORATED, San Diego, CA (US)

(72) Inventors: Sai Pradeep VENKATRAMAN, Santa Clara, CA (US); Benjamin A. WERNER, San Carlos, CA (US)

(73) Assignee: QUALCOMM INCORPORATED, San Diego, CA (US)

(21) Appl. No.: 13/798,062

(22) Filed: Mar. 12, 2013

(51) Int. Cl. H04W 4/04

(52) U.S. Cl. CPC H04W 4/04
USPC 455/456.1

(57) ABSTRACT

A method of predicting positioning performance of a set of N access points in an indoor region includes: obtaining a signal-strength map including signal-strength vectors and corresponding locations in the indoor region, the signal-strength vectors each including N signal-strength indications that each indicate an expected received signal strength from a corresponding one of the set of N access points; and determining a position uncertainty value using the signal-strength map, the position uncertainty value being indicative of a positioning accuracy at a corresponding point of interest in the indoor region.

### BACKGROUND

Indoor position determination of mobile devices presents issues not encountered outdoors. For example, indoor positioning relies on map features such as walls, partitions, infeasible areas, etc. Consequently, heatmaps may be used that take in to account such features to provide a predicted heatmap of received signal strength indication (RSSI) as a function of position. A positioning engine uses RSSI or a range vector to calculate a position fix that best matches the predicted heatmap.

Positioning performance can be predicted using the geometry of an indoor environment and known locations of access points (APs). Geometric dilution of position (GDOP) uses the geometry of “visible” APs, i.e., those APs whose RSSI exceeds a threshold, to compute a scalar value representing the dilution of precision. GDOP assumes that measurements on the statespace are linear and that the error distribution is Gaussian. This is not the situation in indoor environments due in part to close-in geometry of APs with respect to a user, and due to obstructions of signals from the APs.

### SUMMARY

An example method of predicting positioning performance of a set of N access points in an indoor region includes: obtaining a signal-strength map including signal-strength vectors and corresponding locations in the indoor region, the signal-strength vectors each including N signal-strength indications that each indicate an expected received signal strength from a corresponding one of the set of N access points; and determining a position uncertainty value using the signal-strength map, the position uncertainty value being indicative of a positioning accuracy at a corresponding point of interest in the indoor region.

Implementations of such a method may include one or more of the following features. Determining the position uncertainty value comprises: determining a distance metric between a position-of-interest vector and a sample vector obtained from the signal-strength map, the position-of-interest vector corresponding to a first location in the indoor region and the sample vector corresponding to a second location in the indoor region; and determining the position uncertainty value based on the first location and the second location. Determining the position uncertainty value based on the first location and the second location comprises determining the position uncertainty value based on dimensions of a first area of the signal-strength map that includes the first location and based on dimensions of a second area of the signal-strength map that includes the second location. Determining the position uncertainty value comprises summing the first area and the second area.

Also or alternatively, implementations of the method may include one or more of the following features. Determining the position uncertainty value comprises: implementing a particle filter using the signal-strength map; and determining the position uncertainty value based on vectors corresponding to particles of the particle filter once the particle filter is stable. Determining the position uncertainty value comprises: determining sample vectors within a threshold distance metric value of a position-of-interest vector corresponding to a first location, the sample vectors corresponding to second locations; and determining the position uncertainty value based on the first location, the second locations, and a variance of the sample vectors. The sample vectors are within a threshold distance of the first location. The method further includes producing a performance map with an indication of the position uncertainty value at a corresponding location in the performance map.

An example apparatus includes: a processor configured to obtain a signal-strength map including signal-strength vectors and corresponding locations in an indoor region, the signal-strength vectors each including N signal-strength indications that each indicate an expected received signal strength from a corresponding one of a set of N access points; and an uncertainty module communicatively coupled to the processor and configured to determine a position uncertainty value using the signal-strength map, the position uncertainty value being indicative of a positioning accuracy at a corresponding point of interest in the indoor region.

Implementations of such an apparatus may include one or more of the following features. The uncertainty module is configured to determine the position uncertainty value by: determining a distance metric between a position-of-interest vector and a sample vector obtained from the signal-strength map, the position-of-interest vector corresponding to a first location in the indoor region and the sample vector corresponding to a second location in the indoor region; and determining the position uncertainty value based on the first location and the second location. The uncertainty module is configured to determine the position uncertainty value based on the first location and the second location by determining the position uncertainty value based on dimensions of a first area of the signal-strength map that includes the first location and based on dimensions of a second area of the signal-strength map that includes the second location. Determining the position uncertainty value comprises summing the first area and the second area.

Also or alternatively, implementations of the apparatus may include one or more of the following features. The uncertainty module is configured to determine the position uncertainty value by: implementing a particle filter using the signal-strength map; and determining the position uncertainty value based on vectors corresponding to particles of the particle filter once the particle filter is stable. The uncertainty module is configured to determine the position uncertainty value by: determining sample vectors within a threshold distance metric value of a position-of-interest vector corresponding to a first location, the sample vectors corresponding to second locations; and determining the position uncertainty value based on the first location, the second locations, and a variance of the sample vectors. The sample vectors are within a threshold distance of the first location. The processor is configured to produce a performance map with an indication of the position uncertainty value at a corresponding location in the performance map.

Another example apparatus includes: obtaining means for obtaining a signal-strength map including signal-strength vectors and corresponding locations in an indoor region, the signal-strength vectors each including N signal-strength indications that each indicate an expected received signal strength from a corresponding one of a set of N access points; and uncertainty means, communicatively coupled to the obtaining means, for determining a position uncertainty value using the signal-strength map, the position uncertainty value being indicative of a positioning accuracy at a corresponding point of interest in the indoor region.

Implementations of such an apparatus may include one or more of the following features. The uncertainty means are configured to determine the position uncertainty value by: determining a distance metric between a position-of-interest vector and a sample vector obtained from the signal-strength map, the position-of-interest vector corresponding to a first location in the indoor region and the sample vector corresponding to a second location in the indoor region; and determining the position uncertainty value based on the first location and the second location. The uncertainty means are configured to determine the position uncertainty value based on the first location and the second location by determining the position uncertainty value based on dimensions of a first area of the signal-strength map that includes the first location and based on dimensions of a second area of the signal-strength map that includes the second location. Determining the position uncertainty value comprises summing the first area and the second area.

Also or alternatively, implementations of the apparatus may include one or more of the following features. The uncertainty means are configured to determine the position uncertainty value by: implementing a particle filter using the signal-strength map; and determining the position uncertainty value based on vectors corresponding to particles of the particle filter once the particle filter is stable. The uncertainty means are configured to determine the position uncertainty value by: determining sample vectors within a threshold distance metric value of a position-of-interest vector corresponding to a first location, the sample vectors corresponding to second locations; and determining the position uncertainty value based on the first location, the second locations, and a variance of the sample vectors. The sample vectors are within a threshold distance of the first location. The apparatus further includes means for producing a performance map with an indications of the position uncertainty value at a corresponding location in the performance map.

An example processor-readable storage medium includes processor-readable instructions configured to cause a processor to: obtain a signal-strength map including signal-strength vectors and corresponding locations in an indoor region, the signal-strength vectors each including N signal-strength indications that each indicate an expected received signal strength from a corresponding one of a set of N access points; and determine a position uncertainty value using the signal-strength map, the position uncertainty value being indicative of a positioning accuracy at a corresponding point of interest in the indoor region.

Implementations of such an apparatus may include one or more of the following features. The instructions configured to cause the processor to determine the position uncertainty value are configured to cause the processor to determine the position uncertainty value by: determining a distance metric between a position-of-interest vector and a sample vector obtained from the signal-strength map, the position-of-interest vector corresponding to a first location in the indoor region and the sample vector corresponding to a second location in the indoor region; and determining the position uncertainty value based on the first location and the second location. The instructions configured to cause the processor to determine the position uncertainty value based on the first location and the second location are configured to cause the processor to determine the position uncertainty value based on dimensions of a first area of the signal-strength map that includes the first location and based on dimensions of a second area of the signal-strength map that includes the second location. The instructions configured to cause the processor to determine the position uncertainty value based on dimensions of the first area and the second area are configured to cause the processor to determine the position uncertainty value by summing the first area and the second area.

Also or alternatively, implementations of the apparatus may include one or more of the following features. The instructions configured to cause the processor to determine the position uncertainty value are configured to cause the processor to: implement a particle filter using the signal-strength map; and determine the position uncertainty value based on vectors corresponding to particles of the particle filter once the particle filter is stable. The instructions configured to cause the processor to determine the position uncertainty value are configured to cause the processor to determine the position uncertainty value by: determining sample vectors within a threshold distance metric value of a position-of-interest vector corresponding to a first location, the sample vectors corresponding to second locations; and determining the position uncertainty value based on the first location, the second locations, and a variance of the sample vectors. The sample vectors are within a threshold distance of the first location. The processor-readable storage medium further includes instructions configured to cause the processor to produce a performance map with an indication of the position uncertainty value at a corresponding location in the performance map.

Items and/or techniques described herein may provide one or more of the following capabilities, as well as other capabilities not mentioned. Positioning performance can be predicted based on a received signal strength map. Positioning performance can be predicted taking account of propagation characteristics of an environment in addition to geometry. Access point locations can be adjusted based on predicted positioning performance. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTION OF THE DRAWINGS

FIG. 1 is a simplified diagram of a communication system.

FIG. 2 is a simplified diagram of access points and a mobile device in a structure shown in FIG. 1.

FIG. 3 is a block diagram of an apparatus shown in FIG. 1.

FIG. 4 is a functional block diagram of the apparatus shown in FIG. 3.

FIG. 5 is a layout of signal-strength map.

FIG. 6 is a block flow diagram of a process of predicting positioning performance as a function of location.

FIG. 7 is a block flow diagram of an example process of determining position uncertainty values for the process shown in FIG. 6.

FIG. 8 is a block flow diagram of another example process of determining position uncertainty values for the process shown in FIG. 6.

### DETAILED DESCRIPTION

Techniques are provided for predicting positioning performance, especially in an indoor region. A map, referred to as a heatmap, of expected RSSI as a function of position is used to predict positioning performance. For example, heatmap data may be used to perform an importance sampling and compute a horizontal estimated position error (HEPE). A set of points in three dimensional space with a connectivity graph showing feasible user motion is considered. At each point, an N-dimensional vector of RSSI values corresponding to N access points is available. These values are the expected RSSI values at a given point, referred to as an RSSI heat map. For each point in the set, the expected RSSI values of the N-dimensional vector are used as the measurements in a particle filter. The particle filter is initialized with a wide distribution over the set of points and feasible paths. The particle filter is then allowed to propagate using the feasible paths and the measurements previously derived. After an amount of time, the covariance of the particles representing the positioning distribution is calculated using an importance sampling. From the covariance, a HEPE calculation is used as the metric of positioning accuracy. A HEPE map may be produced that is a map from all points of interest to a metric of positioning accuracy at those points of interest. Other examples may be implemented according to the discussion herein.

Also or alternatively, correlations between RSSI vectors of different nodes can be determined to assess distinguishability between the RSSI vectors at the different locations corresponding to the nodes. A distance function can be calculated using the RSSI vectors of different nodes. If the function yields a result indicating that the RSSI vectors have low uniqueness (i.e., are similar, not very distinguishable), then an uncertainty metric may be calculated to indicate a position uncertainties (i.e., uncertainties of positioning) at locations in the indoor region. The RSSI vectors can be determined to have low uniqueness, for example, if the function yields a result that indicates that the RSSI vectors are closer than a threshold level of closeness. For example, a covariance of the vectors may be determined, with a wide covariance indicating a high positioning uncertainty for the two nodes, and a small covariance indicating a low positioning uncertainty.

Positioning performance, i.e., the accuracy in determining position of a device in an indoor environment, depends on the uniqueness of RSSI patterns in the heatmap of predicted RSSI as a function of position. Performance prediction is useful in the provision of indoor positioning systems, both to manage expectations of positioning accuracy and to recommend changes to the systems and/or the environment to improve positioning performance.

Referring to FIGS. 1-2, a communication system 10 includes mobile devices 12, a base transceiver station (BTS) 14, a network 16, a server 18, and access points (APs) 20 disposed in structures (e.g., buildings) 22. The system 10 is a communication system in that the system 10 can at least send and receive communications. Although only one server 18 is shown for simplicity, more than one server 18 may be used in the system 10, e.g., in various locations to provide quicker access as the system 10 may span large regions, e.g., entire countries or continents, or even the planet.

The BTS 14 can wirelessly communicate with the mobile devices 12 via antennas. Each of the BTSs 14 may also be referred to as an access point, an access node (AN), a Node B, an evolved Node B (Enb), etc. The BTSs 14 are configured to communicate wirelessly with the mobile devices 12 under the control of the server 18 (via the network 16).

The mobile devices 12 can be moved to various locations, including into the structures 22 and onto different floors of the structures 22. The mobile devices 12 may be referred to as access terminals (ATs), mobile stations (MSs), user equipment (UE), or subscriber units. The mobile devices 12 are shown here as cellular phones. Other examples of mobile devices include wireless routers, personal digital assistants (PDAs), netbooks, notebook computers, tablet computers, etc. Only one mobile device 12 is shown in FIG. 2, and to simplify the discussion below only this mobile device 12 is discussed.

The server 18 preferably can communicate with the APs 20 within the structures 22 through the network 16. The APs 20 are preferably hard-wire connected to the network 16 and include wireless transceivers.

Referring to FIG. 3, a computing apparatus 30 comprises a computer system including a processor 32, a memory 34 including software 36, a display 38, and a network interface 39. The apparatus 30 may be a part of the system 10 shown in FIG. 1, e.g., may be the server 18, or may be separate from the system 10. The processor 32 is preferably an intelligent hardware device, e.g., a central processing unit (CPU) such as those made by ARM®, Intel® Corporation, or AMD®, a microcontroller, an application specific integrated circuit (ASIC), etc. The processor 32 could comprise multiple separate physical entities that can be distributed in the apparatus 30. The memory 34 includes random access memory (RAM) and read-only memory (ROM). The memory 34 is a processor-readable storage medium that stores the software 64 which is processor-readable, processor-executable software code containing instructions that are configured to, when executed, cause the processor 32 to perform various functions described herein (although the description may refer only to the processor 32 performing the functions). Alternatively, the software 36 may not be directly executable by the processor 32 but configured to cause the processor 32, e.g., when compiled and executed, to perform the functions. The display 38 is configured to provide visual indications and may be, e.g., a liquid-crystal display, a touch-screen display, etc. The processor 32 is communicatively coupled to each of the memory 34, the display 38, and the network interface 39. The network interface 39 is configured to send information to, and receive information from, the network 16 (FIG. 1).

Referring to FIG. 4, the apparatus 30 includes a distance metric module 42, particle filter module 43, and an uncertainty metric module 44. The modules 42, 43, 44 are functional modules implemented by the processor 32 and the software 36 stored in the memory 34, although the modules 42, 43, 44 could be implemented in hardware, firmware, or software, or combinations of these. Thus, reference to the modules 42, 43, 44 performing or being configured to perform a function is shorthand for the processor 32 performing or being configured to perform the function in accordance with the software 36 (and/or firmware, and/or hardware of the processor 32). Similarly, reference to the processor 32 determining a distance metric, implementing a particle filter, or determining an uncertainty metric (or performing functions toward any of these ends) is equivalent to the distance metric module 42, the particle filter module 43, or the uncertainty module 44, respectively, performing the function. The distance metric module 42, or distance metric means or means for determining a distance metric, is configured to compute an indication of similarity/dissimilarity between signal-strength vectors in a signal-strength map. Also or alternatively, the distance metric module can implement a particle filter, with particles corresponding to similar vectors (e.g., according to a distance metric) congregating together in groups, with the locations of the groups determined by the vectors of the particles such that different groups of particles may congregate in different locations. Two examples of operation of the distance metric module 42 are discussed below with respect to FIGS. 7-8, although the distance metric module 42 may operate in one or more other ways as well. The particle filter module 43, or particle filter means or means for implementing a particle filter, is configured to initialize particles of a particle filter, to propagate a particle filter belief to the particles, and to apply measurements to the particles by changing weights of the particles, as discussed below with respect to FIG. 7. The uncertainty module 44, uncertainty means or means for determining an uncertainty metric, is configured to compute an indication of positioning uncertainty based on signal-strength vectors and/or associated information from the signal-strength map for signal-strength vectors identified by the distance metric module 42. An example of operation of the uncertainty module 44 is discussed below with respect to FIG. 8, although the uncertainty module 44 may operate in one or more other ways as well. Further, the distance metric module 42 may be omitted, e.g., if the signal-strength map indicates which combination(s) of vectors is(are) to be operated on by the uncertainty module 44, or if the uncertainty module 44 can determine the combination(s) of vectors on which to operate.

An example signal-strength map 50 is shown in FIG. 5. Solid lines in the map 50 indicate structural objects, such as walls, of the region covered by the map 50. While the example in FIG. 5 only shows walls, numerous other objects that may affect signal propagation (e.g., signal-to-noise ratio, SNR) may be considered, e.g., furniture, interference sources. Further, objects or combinations of objects may act like waveguides. The map 50 includes nodes 52, with each node having a corresponding signal-strength vector and location. The signal-strength vector is a combination of estimated received signal strengths from each of N access points 20 in a region of the structure 22, e.g., a floor of the structure 22. The estimated received signal strengths are estimated using propagation characteristics of the region such as the geometry of the region, the locations of the access points 20, the geometry of walls or other objects affecting propagation of wireless signals, composition of objects such as the interior walls and exterior/outer walls of the region, etc. In this example, the nodes 52 are disposed in a grid, being evenly spaced horizontally and evenly spaced vertically (but with the vertical spacing different from the horizontal spacing), but the nodes 52 could be arranged in other ways, e.g., randomly, in a non-uniform grid, in an uneven distribution, e.g., with a higher concentration of the nodes 52 in one or more areas, etc. The nodes 52 are disposed in corresponding cells 54. In this example, the cells 54 are equal-sized rectangles, but other shapes could be used including irregular shapes or even overlapping shapes. Further, different cells 54 may be of different shapes, and/or may have different sizes and corresponding areas. The signal-strength map 50 may be referred to as a heatmap, as signal-strength maps are often displayed in color, with different colors representing different received signal strength, and often with a similar color scheme as indications of heat, e.g., red indicating high signal strength and blue representing low signal strength.

Referring to FIG. 6, with further reference to FIGS. 1-4, a process 60, in the apparatus 30, of predicting positioning performance of a set of N access points in an indoor region includes the stages shown. The process 60 is, however, an example only and not limiting. The process 60 can be altered, e.g., by having stages altered, added, removed, combined, and/or performed concurrently.

At stage 62, the process 60 includes obtaining a signal-strength map including signal-strength vectors and corresponding locations in an indoor region, the signal-strength vectors each including N signal-strength indications that each indicate an expected received signal strength from a corresponding one of the N access points. For example, the processor 32 accesses the signal-strength map that is stored in the memory 34. This may further involve receiving the signal-strength map, e.g., through a wired or wireless communication mechanism, and storing the signal-strength map in the memory 34. Alternatively, the processor 32 may access the signal-strength map through a communication connection with or without transferring and storing the signal-strength map in the memory 34.

At stage 64, the process 60 includes determining position uncertainty values, corresponding to points of interest in the indoor region, using the signal-strength map. The uncertainty module 44 uses information in the signal-strength map to compute position uncertainty values for different locations in the indoor region. The uncertainty module 44 provides a position performance prediction map, i.e., an association, of the position uncertainty values and the corresponding locations. Each position uncertainty value indicates the uncertainty that a position, determined to be at the corresponding location, will be accurate. For example, the position uncertainty value may indicate a size of an area that includes the determined position and over which the precise location of an object whose position is being determined is ambiguous. That is, based on a measured signal-strength vector at the object, the location of the object may be anywhere within an area the size of which is indicated by the position uncertainty value. As another example, the uncertainty module 44 can determine sample vectors within a threshold distance metric value of a position-of-interest vector, the location of the position of interest being a first location, and the sample vectors corresponding to second locations. The uncertainty value can be based on the first location, the second locations, and a variance of the sample vectors.

Referring to FIG. 7, with further reference to FIGS. 1-6, a process 70, in the apparatus 30, of determining the position uncertainty values of stage 54 of FIG. 6 includes the stages shown. The process 70 is, however, an example only and not limiting. The process 70 can be altered, e.g., by having stages altered, added, removed, combined, and/or performed concurrently. The process 70 implements a particle filter and determines an uncertainty based on positions of the particles and a position of interest, and corresponding vector values of the position of interest and the particles.

At stage 72, a position of interest pᵢ is selected. The particle filter module 43 selects a new value of the position of interest pᵢ or, if this is the first performance of stage 72, sets the position of interest pᵢ to an initial value. The position of interest pᵢ is a position within the signal-strength map 50.

At stage 73, a particle filter is initialized. The particle filter module 43 initializes the particle filter with particles distributed widely around the position of interest pᵢ. The particles preferably are distributed evenly about the position of interest pᵢ and at various physical distances from the position of interest pᵢ.

At stage 74, a measurement set m is simulated for the position of interest pᵢ. The particle filter module 43 simulates a signal-strength vector at the position of interest pᵢ, i.e., a position-of-interest signal-strength vector or more simply, a position-of-interest vector. The particle filter module 43 simulates the position-of-interest vector using a measurement model such as a Gaussian measurement model to form the position-of-interest vector as the mean of neighboring vectors. For example, with the position of interest 56 shown in FIG. 5, the measurement set m is the position-of-interest vector which is a mean of the vectors corresponding to the nodes 52_{3,3}, 52_{3,4}, 52_{4,3}, 52_{4,4}.

At stage 76, a particle filter belief is propagated. The particle filter module 43 starts a timer and propagates a filter belief across all the particles in the particle filter. The particle filter module 43 applies a propagation model that allows the particles to move according to expected movement in the region of the signal-strength map 50. For example, the propagation model simulates expected movements of users in a building, limited by constraints/objects in the region such as walls. A propagation filter is based on a connectivity map that has indications, e.g., edges, of feasible paths for a user to use to move between points in the connectivity map.

At stage 78, the measurement set m is applied to the particle filter belief. The particle filter module 43 applies the measurement set m to the particle filter belief by changing weights of the particles using the signal-strength map. The particle filter module 43 updates the weights of the particles based on simulated measurements and determines whether the simulated measurements match the particle locations. The particle filter module 43 may, optionally, resample the particles.

At stage 80, an inquiry is made as to whether the particle filter belief should be propagated longer. The particle filter module 43 checks whether the particle filter is stable, e.g., checks the timer to see if the particle filter belief has been propagated for a predetermined desired amount of time, i.e., that the timer has expired. If the particle filter belief is to be propagated more (i.e., the timer has yet to expire), then the process 70 returns to stage 76. If the particle filter propagation is to be stopped, e.g., once the particle filter is stable (e.g., the particles move less than a threshold distance between iterations) then the process 70 proceeds to stage 82.

At stage 82, an uncertainty metric uncᵢ is computed and stored in association with the position of interest pᵢ. The uncertainty module 44 calculates a metric of position uncertainty uncᵢ using the location of the position of interest, the position-of-interest vector, the particle positions, and the vector values corresponding to the particles. Also or alternatively, the uncertainty metric may be a covariance of the position-of-interest vector and the vector values of the particles and/or a metric indicating maximum likelihood of location. The uncertainty module 44 may, optionally, determine the uncertainty metric with respect to only the particles within a threshold physical distance of the position of interest pᵢ. A horizontal estimated position error (HEPE) may also be calculated, e.g., as a sum of the squares of lateral (e.g., x and y in FIG. 5) variances in weightings of the position-of-interest vector relative to the vectors of the particles. Also or alternatively, a HEPE may be calculated as a weighted covariance of the particles in the particle filter. The uncertainty module 44 further stores the uncertainty metric uncᵢ in association with the position of interest pᵢ in the memory 34 to form one point of an uncertainty map indicative of predicted position performance as a function of position in the region corresponding to the signal-strength map 50. The predicted position performance map may or may not cover the entirety of the region of the signal-strength map 50 depending upon which positions pᵢ are selected and for which corresponding uncertainties uncᵢ are determined.

At stage 84, an inquiry is made as to whether more positions of interest are to be evaluated. The processor 32 determines whether there is any remaining position of interest to be evaluated. If so, then the process 70 returns to stage 72 where a new position of interest is selected. If all desired positions of interest have been evaluated, then the process proceeds to stage 86.

At stage 86, an uncertainty map is produced and output, i.e., the process 70 includes producing and outputting the uncertainty map. The uncertainty module 44 outputs the uncertainty map, i.e., data indicating positions of interest and corresponding predicted positioning performance/positioning accuracy. The uncertainty module 44 may, for example, output a visual indication of the uncertainty map to the display 38 for visual indication to a user of the predicted positioning performance as a function of position. The user may use this information, e.g., to rearrange locations of the APs 20, to remove one or more APs 20, or to add one or more APs 20 servicing the region corresponding to the signal-strength map 50.

Referring to FIG. 8, with further reference to FIGS. 1-6, a process 110, in the apparatus 30, of determining the position uncertainty values of stage 54 of FIG. 6 includes the stages shown. The process 110 is, however, an example only and not limiting. The process 110 can be altered, e.g., by having stages altered, added, removed, combined, and/or performed concurrently. For example, stages 114 and 116 discussed below may be combined. The process 110 determines a spatial window of nodes with similar vectors, e.g., small distance metrics, as a measure of positioning performance. The process 110 uses the signal-strength map 50. The process 110 may, however, be used with other maps, or may use fewer than all the data from a signal-strength map, e.g., using fewer than all the nodes of a signal-strength map, e.g., to reduce computational complexity.

At stage 112, a test node is selected for evaluation of the positioning performance at that node. The distance metric module 42 selects a node 52 from the signal-strength map 50. As an example, the distance metric module 42 selects the node 52_{3,3} as the test node. The distance metric module 42 may select the nodes 52 in a variety of ways, e.g., by stepping through the nodes 52 systematically (e.g., row by row, and across within each row) or randomly or some other way. The distance metric module 42 may eventually select all the nodes 52 of the signal-strength map 50, or may select fewer than all of the nodes 52. Further, the distance metric module 42 may choose a test node position that does not correspond to one of the nodes 52 of the signal-strength map 50 (similar to stage 72 discussed above with respect to FIG. 7). In this case, a vector for the test node may be determined (e.g., similarly to stage 74 discussed above with respect to FIG. 7).

At stage 114, neighbor nodes are selected for determining a distance metric relative to the test node. Neighbor nodes are nodes 52 that are determined to be relevant to the distance metric calculation(s) for the selected test node. All the nodes 52 other than the test node could be considered neighbor nodes. Alternatively, which nodes 52 are neighbor nodes for any particular test node may be determined based on one or more of various factors such as geographical proximity and/or actual or expected strength of one or more received signals. For example, the neighbor nodes 52 may be all of the nodes 52 in the signal-strength map 50 or may be only those nodes that are geographically close (e.g., no more than one column and one row away from the test node, or no more than two columns and two rows away from the test node). As other examples, the neighbor nodes could be the nodes 52 from which the expected RSSI at the test node exceeds an RSSI threshold, or the N nodes with the highest expected RSSI at the test node, etc. Using FIG. 5 as an example, the neighbor nodes are all the nodes 52 that are no more than two columns and two rows away from the test node (i.e., within two hops of the test node). For this example, the neighbor nodes are thus all of the nodes 52 in the signal-strength map 50. The signal-strength map 50, however, may be part of a larger map, and thus not represent an entire region (e.g., floor) of the structure 22, in which case the neighbor nodes would be less than all the nodes of the larger map.

At stage 116, a distance metric is calculated between the test node vector and each of the neighbor node vectors. The distance metric module 42 determines a distance between the test node vector (i.e., the RSSI vector at the test node), here the node 52_{3,3}, and each of the vectors of the corresponding neighbor nodes 52 (i.e., a similarity between the vector at the test node and the vectors corresponding to the neighbor nodes). For example, a covariance can be determined between the test node vector and each of the vectors of the neighbor nodes to determine a correlation between the test node vector and the neighbor node vectors.

At stage 118, an uncertainty metric is determined for the test node. The uncertainty module 44 determines an uncertainty metric based on the distance metrics determined at stage 116. In this example, the uncertainty module 44 uses the distance metrics to identify similar neighbor nodes (i.e., neighbor nodes with vectors similar to the test node vector). The similar neighbor nodes are the neighbor nodes whose corresponding distance metric indicates that the neighbor node vector and the test node vector were similar enough that the test node vector would not uniquely distinguish between the test node and the neighbor node, e.g., that the distance metric was within a distance threshold value (i.e., less than the distance threshold value or less than or equal to the distance threshold value). The distance metric being within the distance threshold value could correspond to a covariance being beyond a covariance threshold value. The uncertainty module 44 uses the cells 54 for all of the similar neighbor nodes to determine the uncertainty metric. For example, here, the uncertainty module 44 adds (sums) the areas of the cells 54 of all the similar neighbor nodes and uses the sum as the uncertainty metric either directly, or by converting the sum to the uncertainty metric (e.g., by summing the areas of the cells 54 of the similar neighbor nodes and dividing by the total area of all the cells 54). The uncertainty module 44 stores the uncertainty metric in the memory 34 in association with the test node location.

At stage 120, an inquiry is made as to whether more test nodes are to be evaluated. The distance metric module 42 determines whether there are test nodes that have not yet been evaluated. If so, then the process 110 returns to stage 112 for the selection of another test node, and otherwise the process 110 proceeds to stage 122 where the uncertainty module 44 outputs an uncertainty map or performance map as discussed above with respect to stage 86 of FIG. 7.

Other Considerations

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

1. A method of predicting positioning performance of a set of N access points in an indoor region, the method comprising:
obtaining a signal-strength map including signal-strength vectors and corresponding locations in the indoor region, the signal-strength vectors each including N signal-strength indications that each indicate an expected received signal strength from a corresponding one of the set of N access points; and
determining a position uncertainty value using the signal-strength map, the position uncertainty value being indicative of a positioning accuracy at a corresponding point of interest in the indoor region.

2. The method of claim 1 wherein determining the position uncertainty value comprises:
determining a distance metric between a position-of-interest vector and a sample vector obtained from the signal-strength map, the position-of-interest vector corresponding to a first location in the indoor region and the sample vector corresponding to a second location in the indoor region; and
determining the position uncertainty value based on the first location and the second location.

3. The method of claim 2 wherein determining the position uncertainty value based on the first location and the second location comprises determining the position uncertainty value based on dimensions of a first area of the signal-strength map that includes the first location and based on dimensions of a second area of the signal-strength map that includes the second location.

4. The method of claim 3 wherein determining the position uncertainty value comprises summing the first area and the second area.

5. The method of claim 1 wherein determining the position uncertainty value comprises:
implementing a particle filter using the signal-strength map; and
determining the position uncertainty value based on vectors corresponding to particles of the particle filter once the particle filter is stable.

6. The method of claim 1 wherein determining the position uncertainty value comprises:
determining sample vectors within a threshold distance metric value of a position-of-interest vector corresponding to a first location, the sample vectors corresponding to second locations; and
determining the position uncertainty value based on the first location, the second locations, and a variance of the sample vectors.

7. The method of claim 6 wherein the sample vectors are within a threshold distance of the first location.

8. The method of claim 1 further comprising producing a performance map with indications of the position uncertainty value at a corresponding location in the performance map.

9. An apparatus comprising:
a processor configured to obtain a signal-strength map including signal-strength vectors and corresponding locations in an indoor region, the signal-strength vectors each including N signal-strength indications that each indicate an expected received signal strength from a corresponding one of a set of N access points; and
an uncertainty module communicatively coupled to the processor and configured to determine a position uncertainty value using the signal-strength map, the position uncertainty value being indicative of a positioning accuracy at a corresponding point of interest in the indoor region.

10. The apparatus of claim 9 wherein the uncertainty module is configured to determine the position uncertainty value by:
determining a distance metric between a position-of-interest vector and a sample vector obtained from the signal-strength map, the position-of-interest vector corresponding to a first location in the indoor region and the sample vector corresponding to a second location in the indoor region; and
determining the position uncertainty value based on the first location and the second location.

11. The apparatus of claim 10 the uncertainty module is configured to determine the position uncertainty value based on the first location and the second location by determining the position uncertainty value based on dimensions of a first area of the signal-strength map that includes the first location and based on dimensions of a second area of the signal-strength map that includes the second location.

12. The apparatus of claim 11 wherein determining the position uncertainty value comprises summing the first area and the second area.

13. The apparatus of claim 9 wherein the uncertainty module is configured to determine the position uncertainty value by:
implementing a particle filter using the signal-strength map; and
determining the position uncertainty value based on vectors corresponding to particles of the particle filter once the particle filter is stable.

14. The apparatus of claim 9 wherein the uncertainty module is configured to determine the position uncertainty value by:
determining sample vectors within a threshold distance metric value of a position-of-interest vector corresponding to a first location, the sample vectors corresponding to second locations; and
determining the position uncertainty value based on the first location, the second locations, and a variance of the sample vectors.

15. The apparatus of claim 14 wherein the sample vectors are within a threshold distance of the first location.

16. The apparatus of claim 9 wherein the processor is configured to produce a performance map with indications of the position uncertainty value at a corresponding location in the performance map.

17. An apparatus comprising:
obtaining means for obtaining a signal-strength map including signal-strength vectors and corresponding locations in an indoor region, the signal-strength vectors each including N signal-strength indications that each indicate an expected received signal strength from a corresponding one of a set of N access points; and
uncertainty means, communicatively coupled to the obtaining means, for determining a position uncertainty value using the signal-strength map, the position uncertainty value being indicative of a positioning accuracy at a corresponding point of interest in the indoor region.

18. The apparatus of claim 17 wherein the uncertainty means are configured to determine the position uncertainty value by:
determining a distance metric between a position-of-interest vector and a sample vector obtained from the signal-strength map, the position-of-interest vector corresponding to a first location in the indoor region and the sample vector corresponding to a second location in the indoor region; and
determining the position uncertainty value based on the first location and the second location.

19. The apparatus of claim 18 the uncertainty means are configured to determine the position uncertainty value based on the first location and the second location by determining the position uncertainty value based on dimensions of a first area of the signal-strength map that includes the first location and based on dimensions of a second area of the signal-strength map that includes the second location.

20. The apparatus of claim 19 wherein determining the position uncertainty value comprises summing the first area and the second area.

21. The apparatus of claim 17 wherein the uncertainty means are configured to determine the position uncertainty value by:
implementing a particle filter using the signal-strength map; and
determining the position uncertainty value based on vectors corresponding to particles of the particle filter once the particle filter is stable.

22. The apparatus of claim 17 wherein the uncertainty means are configured to determine the position uncertainty value by:
determining sample vectors within a threshold distance metric value of a position-of-interest vector corresponding to a first location, the sample vectors corresponding to second locations; and
determining the position uncertainty value based on the first location, the second locations, and a variance of the sample vectors.

23. The apparatus of claim 22 wherein the sample vectors are within a threshold distance of the first location.

24. The apparatus of claim 17 further comprising means for producing a performance map with indications of the position uncertainty value at corresponding location in the performance map.

25. A processor-readable storage medium comprising processor-readable instructions configured to cause a processor to:
obtain a signal-strength map including signal-strength vectors and corresponding locations in an indoor region, the signal-strength vectors each including N signal-strength indications that each indicate an expected received signal strength from a corresponding one of a set of N access points; and
determine a position uncertainty value using the signal-strength map, the position uncertainty value being indicative of a positioning accuracy at a corresponding point of interest in the indoor region.

26. The processor-readable storage medium of claim 25 wherein the instructions configured to cause the processor to determine the position uncertainty value are configured to cause the processor to determine the position uncertainty value by:
determining a distance metric between a position-of-interest vector and a sample vector obtained from the signal-strength map, the position-of-interest vector corresponding to a first location in the indoor region and the sample vector corresponding to a second location in the indoor region; and
determining the position uncertainty value based on the first location and the second location.

27. The processor-readable storage medium of claim 26 the instructions configured to cause the processor to determine the position uncertainty value based on the first location and the second location are configured to cause the processor to determine the position uncertainty value based on dimensions of a first area of the signal-strength map that includes the first location and based on dimensions of a second area of the signal-strength map that includes the second location.

28. The processor-readable storage medium of claim 27 the instructions configured to cause the processor to determine the position uncertainty value based on dimensions of the first area and the second area are configured to cause the processor to determine the position uncertainty value by summing the first area and the second area.

29. The processor-readable storage medium of claim 25 wherein the instructions configured to cause the processor to determine the position uncertainty value are configured to cause the processor to:
implement a particle filter using the signal-strength map; and
determine the position uncertainty value based on vectors corresponding to particles of the particle filter once the particle filter is stable.

30. The processor-readable storage medium of claim 25 wherein the instructions configured to cause the processor to determine the position uncertainty value are configured to cause the processor to determine the position uncertainty value by:
determining sample vectors within a threshold distance metric value of a position-of-interest vector corresponding to a first location, the sample vectors corresponding to second locations; and
determining the position uncertainty value based on the first location, the second locations, and a variance of the sample vectors.

31. The processor-readable storage medium of claim 30 wherein the sample vectors are within a threshold distance of the first location.

32. The processor-readable storage medium of claim 25 further comprising instructions configured to cause the processor to produce a performance map with indications of the position uncertainty value at a corresponding location in the performance map.
